(19) United States
(12) Patent Application Publication
(10) Pub. No.: US 2016/0218599 A1
(43) Pub. Date: Jul. 28, 2016

(54) DEVICE FOR POWER CONTROL FOR A ROTATING FIELD MACHINE

(71) Applicant: ZF Friedrichshafen AG, Friedrichshafen (DE)

(72) Inventors: Hans-Jürgen Hanft, Pegnitz (DE); Wilfried Lassmann, Hirschau (DE)

(73) Assignee: ZF Friedrichshafen AG, Friedrichshafen (DE)

(21) Appl. No.: 15/005,339

(22) Filed: Jan. 25, 2016

(30) Foreign Application Priority Data
Jan. 28, 2015 (DE) 10 2015 201 397.9

(51) Int. Cl. H02K 11/02; H02K 11/30; H02K 9/00

(52) U.S. Cl. CPC H02K 11/02; H02K 9/005; H02K 11/30

(57) ABSTRACT

A power control for an inductive machine comprises a printed circuit board having an electronic control element for controlling a current through the inductive machine, an electrical connection of the printed circuit board, a cooling element, connected in a thermally conductive manner to the control element, and a choke at the electrical connection for suppressing interference emissions. The choke is connected thereby to the cooling element in a thermally conductive manner.

The invention relates to a power control for an induction machine. In particular, the invention relates to the suppression of interference fields at the power control.

An induction machine, e.g. a permanently excited synchronous induction machine, comprises numerous cables, the currents of which are controlled by means of electronic control elements. The induction machine can be selectively operated thereby as either a motor or a generator. By way of example, the induction machine can be used as an electric starter generator for an internal combustion engine in a motor vehicle. To start up the internal combustion engine, the induction machine is controlled as a motor, and when the internal combustion engine is running, a necessary electrical power can be provided by the induction machine running in the generator mode. The power control for the induction machine is connected thereby to a direct current branch.

The electrical current flowing from or to the direct current branch may cause high frequency electromagnetic interference fields during the operation of the induction machine. In order to suppress such interference fields, or to produce an electromagnetic compatibility (EMC), an interference suppression is normally executed directly at the connections of the power control by means of a choke and/or a capacitor. A considerable amount of electrical power can be reduced through the interference suppression thereby, and converted to heat, such that the elements used for the interference suppression may reach high temperatures.

It is the object of the present invention to provide an improved power control for an induction machine. The invention achieves this object by means of a power control having the features of the independent Claim. Dependent Claims describe preferred embodiments.

A power control for an induction machine comprises a printed circuit board having an electronic control element for controlling a current through the induction machine, an electrical connection for the printed circuit board, a cooling element, which is connected to the control element in a thermally conductive manner, and a choke at the electric connection for suppressing interference radiations. The choke is connected in a thermally conductive manner thereby to the cooling element.

Because the electronic control element normally does not function without losses, the use of a cooling element is normally necessary. Advantageously, the same cooling element can be used for cooling the choke, such that it can suppress interference emissions in the region of the electrical connection in an improved manner. As a result, the choke can withstand greater loads with the same dimensioning, or with the same power capacity, may have smaller dimensions. The production costs be reduced as a result. A power capacity of the choke can be increased.

The choke is preferably designed as a toroidal core choke surrounding the electrical connection. The electrical connection can be encompassed thereby, following the current direction, by the toroidal core choke. If the current flowing through the connection is only guided once through the interior of the toroidal core choke, then the choke and the electrical connection can have a simple mechanical construction. This embodiment can contribute to the reduction in production costs.

The toroidal core is preferably composed of multiple parts. As a result, the toroidal core can be attached retroactively in a simple manner to the straight or curved electrical connection. In particular, the toroidal core may comprise numerous U-shaped segments, e.g. half-shells. The segments may extend about the interior of the toroidal core choke in rounded shapes or polygonal shapes.

An electrically insulating thermally conductive element can be attached between the choke and the cooling element. The thermally conductive element can comprise a thermally conductive paste, a thermally conductive film, or a suitable casting compound. In another embodiment, the toroidal core is molded around the connection. As a result, the thermal resistance between the choke and the cooling element can be reduced, such that the temperature of the choke can be more readily reduced. As a result of the electrical insulating effect of the thermally conductive element, it is possible to prevent interference radiations being discharged via the cooling element. Furthermore, the cooling element can be electrically connected to the electronic control element. The cooling element can be used thereby as a supply line or a potential equalization between numerous control elements.

In one embodiment, the electrical connection has a rectangular cross section having two short and two long sides, wherein the choke is connected in a thermally conductive manner to the cooling element in the region of one of the long sides. The cross section of the choke can reflect the cross section of the electrical connection thereby. A surface of the choke available for thermal conductivity can be enlarged thereby, by means of which the thermal exchange between the choke and the cooling element can be improved.

In one embodiment, the electrical connection is designed as a circuit path on the printed circuit board. As a result, the connection can be designed such that it is integrated with the printed circuit board in a cost-saving manner. In particular, the electrical connection can exhibit the rectangular cross section described above, wherein the thickness of a printed circuit board is normally only a few tenths of a millimeter, while the width may be numerous millimeters, or more than a centimeter. The aspect ratio of the rectangular cross section is very uneven thereby, such that the surface of the electrical connection in the region of the long side of the rectangular cross section—thus on the upper or lower surface of the printed circuit board—offers a large surface area. If the shape of the cross section of the choke reflects the shape of the cross section of the printed circuit board, then an advantageously large surface area can be used for transferring heat between the choke and the cooling element.

In another embodiment, the choke comprises ferrite. If the choke has a multi-part construction, then numerous ferrite elements may be used. The ferrite elements can abut one another in an electrically conductive manner, or they may be separated from one another, e.g. when the elements are provided individually in protective coatings.

It is furthermore preferred that the printed circuit board have two electrical connections for conducting direct currents that correspond to one another, wherein the choke is designed as a symmetrical toroidal core choke surrounding both electrical connections. As a result, a good suppression of interference radiation can be achieved with a simple construction.

In another embodiment, the choke is designed as an asymmetrical toroidal core choke surrounding only one of the two electrical connections. As a result, the choke can be constructed more simply and more compact.

Combinations are also possible. By way of example, two individual chokes may be provided on the two electrical connections, or an asymmetrical toroidal core choke may be provided on one connection, and, additionally, a symmetrical toroidal core choke may be provided on both connections.

The invention shall now be described in greater detail with reference to the attached figures, in which:

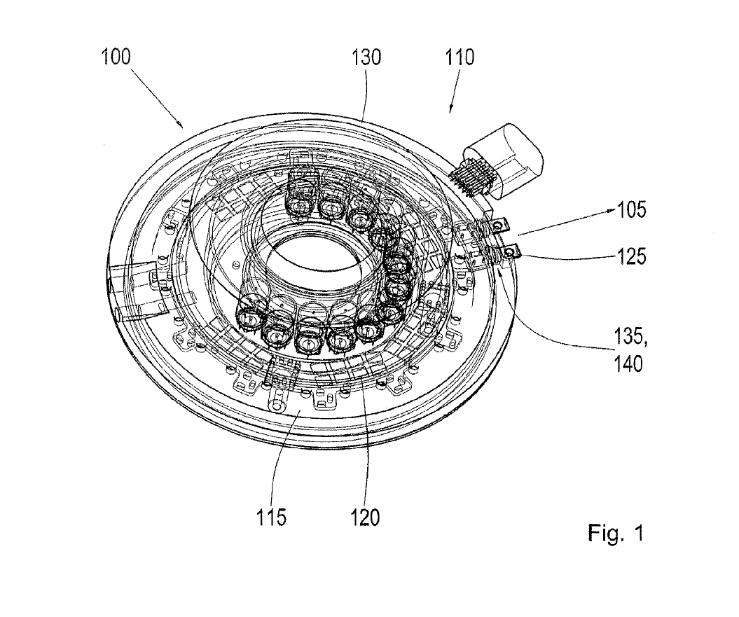

FIG. 1 shows an electrical power control in a first embodiment;

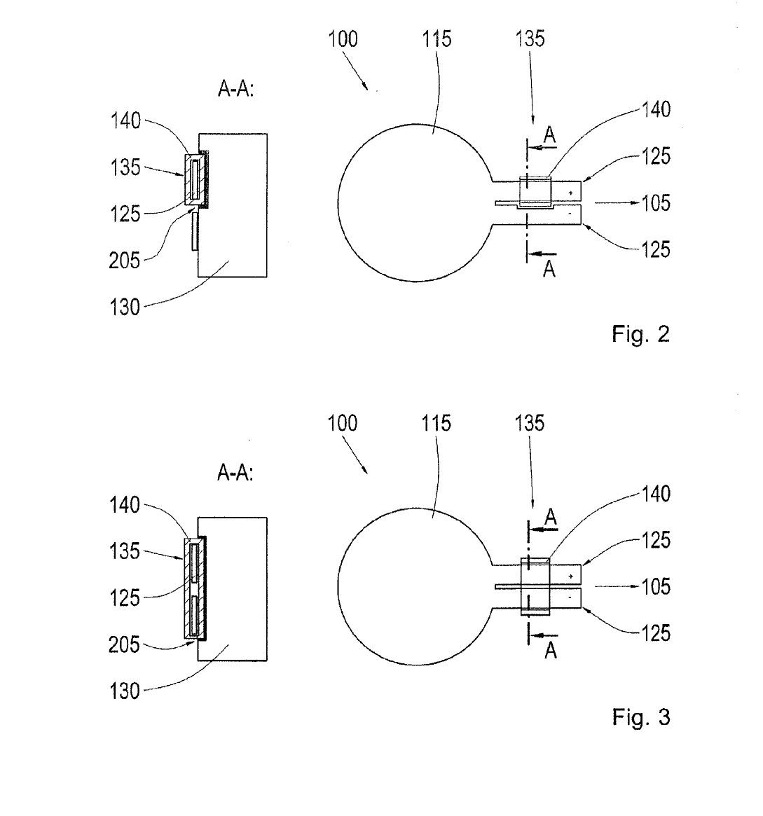

FIGS. 2-4 show schematic depictions of the electrical power control from FIG. 1 in further embodiments; and

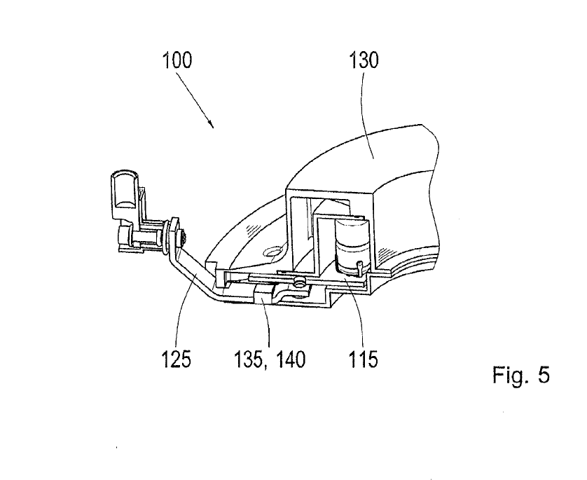

FIG. 5 shows the power control from FIG. 1 in yet another embodiment.

FIG. 1 shows an electrical power control 100 in an exemplary embodiment. The power control 100 is configured for controlling a current between a direct current branch 105, e.g. a vehicle power system on board a motor vehicle and an induction machine 110 (not shown). In the depicted, preferred embodiment, the power control 100 is configured to be attached in a radial interior region of the induction machine 110. The induction machine 110 can comprise, in particular, an electrical starter generator for an internal combustion engine on board the motor vehicle, or it can comprise a hybrid application. The direct current branch 105 can have a direct current voltage of ca. 48V, or some other whole number multiple of ca. 12V, for example. If the induction machine 110 is operated as an electric motor, in particular for starting the internal combustion engine of the motor vehicle, then currents of multiple 100A can be exchanged between the power control 100 and the direct current voltage branch 105, of up to ca. 800A, for example. Greater or lesser dimensionings as a function of the size of the internal combustion engine are likewise possible.

The power control 100 comprises a printed circuit board 115 having an electronic control element 120, an electrical connection 125, a cooling element 130, which is depicted as transparent, and a choke 135 (not shown) in the region of the electrical connection 125. The electrical control element 120 can comprise, in particular, a semiconductor, which lies, electrically, between the connection 125 and a connection for a cable of the induction machine 110. The control element 120 is connected in a thermally conductive manner to the cooling element 130. Preferably two electrical connections 125 are provided for conducting different direct current voltage potentials of the direct current voltage branch 105. Even more electrical connections 125 may be provided.

It is proposed that the choke 135 is formed in the region of at least one connection 125, such that it is connected to the cooling element 130 in a thermally conductive manner. The choke may comprise, in particular, a toroidal core 140 thereby, which may be made of ferrite, for example. The toroidal core 140 comprises an interior space, through which the electrical connection 125 runs at least once. In another embodiment, the electrical connection 125 can also be wound multiple times around the body of the toroidal core 140, such that it passes through the interior space multiple times. The choke 135 has a cushioning effect on high frequency alternating fields, and weakens an electromagnetic emission, such that an electromagnetic compatibility of the power control 100 can be increased.

FIG. 2 shows a schematic depiction of the electrical power control 100 in FIG. 1, in another embodiment. In the left-hand, upper region, a top view of a printed circuit board 115 having two connections 125 is depicted, and a cross section of the printed circuit board 115 in the region of the connections 125 is depicted in the right-hand lower region. The electrical part of the electrical connection 125 is designed as a conductive path on the printed circuit board 115 thereby, which serves as a mechanical substrate. The toroidal core 140 of the choke 135 can be slid onto the connection 125, before the electrical connection 125 is connected to the direct current voltage branch 105. In another embodiment, the toroidal core 140 has a multi-part design, e.g. in the form of U-shaped or shell-shaped elements, which can be mounted around the connection 125, even when the connection 125 is already connected to the direct current voltage 105 or another element.

A cross section of the connection 125, in particular its electrical part, is rectangular here, having a very asymmetrical aspect ratio. The shape of the toroidal core 140 reflects, in its cross section, this very flat and wide rectangle, such that large surfaces of the toroidal core 140 are formed on two opposite sides, which are available for bearing against cooling element 130. A thermally conductive element 205 may be provided between the toroidal core 140 and the cooling element 130, which preferably functions in an electrically insulating manner.

The choke 135 is designed as an asymmetrical filter in the depicted embodiment, which means that of the two provided electrical connections 125, only one runs through the interior space of the toroidal core 140, and thus forms, together therewith, a choke 135.

FIG. 3 shows another embodiment, which is based on that in FIG. 2. Differing therefrom, the choke 135 is provided here as a symmetrical filter in the so-called “common mode,” in which both electrical connections 125 leading to the direct current voltage branch 105 run through the interior space of the toroidal core 140, and thus form the choke 135 collectively. Optionally, the toroidal core 140 can have a carrier between the electrical connections 125, such that two chokes 135 coupled to one another are formed at the individual connections 125. Furthermore, two separate asymmetrical chokes 135, corresponding to the embodiment in FIG. 2, may each be applied to one of the connections 125.

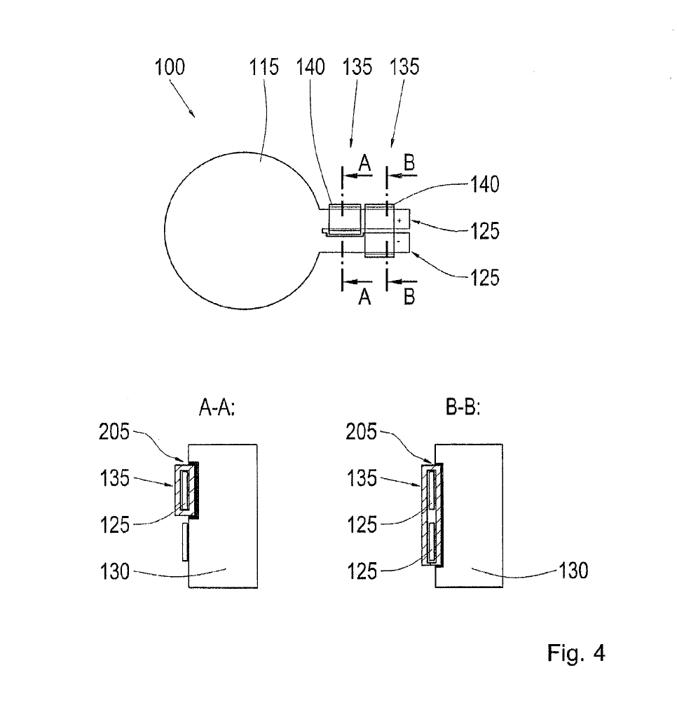

FIG. 4 shows yet another embodiment of the power control 100, comprising a combination of the embodiments in FIGS. 2 and 3. An electrical connection 125 passes through a first toroidal core 140 and a first choke 135 is formed therewith. Both connections 125 pass through a second toroidal core 150 and a second choke 135 is formed therewith.

FIG. 5 shows the power control 100 from FIG. 1 in yet another embodiment. In this case, the electrical connection 125 is not formed as a conductive path on the printed circuit board 115, but rather as a separate element 505, which is electrically connected to the printed circuit board. The choke 135 is again designed in the region of the connection 125 such that it is connected to the cooling element 130 in a thermally conductive manner. It is also preferred in this embodiment that a surface facing toward the cooling element 130 is a large as possible. The cross section of the toroidal core 140 reflects the shape of this surface, in order to implement the largest possible bearing surface for thermal exchange with the cooling element 130. The element 505 can comprise a plate that is connected to the printed circuit board 115 by means of welding, soldering or riveting.

### REFERENCE SYMBOLS

100 electric power control
105 direct current voltage branch
110 inductive machine
115 printed circuit board
120 electronic control element
125 electrical connection
130 cooling element
135 choke
140 toroidal core
205 thermally conductive element
505 element (electrical connection)

1. A power control for an inductive machine, the power control comprising:
a printed circuit board having an electronic control element for controlling a current through the inductive machine;
an electrical connection of the printed circuit board;
a cooling element connected to the control element in a thermally conductive manner; and
a choke at the electrical connection for suppressing interference emissions, wherein the choke is connected to the cooling element in a thermally conductive manner.

2. The power control of claim 1, wherein the choke is designed as a toroidal core surrounding the electrical connection.

3. The power control of claim 2, wherein the toroidal core has a multi-part construction.

4. The power control of claim 1, wherein an electrically insulating thermally conductive element is mounted between the choke and the cooling element.

5. The power control of claim 1, wherein a cross section of the electrical connection is rectangular, having two short and two long sides, and the choke is connected to the cooling element in a thermally conductive manner in the region of a long side.

6. The power control of claim 1, wherein the electrical connection is designed as a conductive path on the printed circuit board.

7. The power control of claim 1, wherein the electrical connection is designed as a separate element, electrically connected to the printed circuit board.

8. The power control of claim 1, wherein the choke comprises ferrite.

9. The power control of claim 1, wherein the printed circuit board has two electrical connections for conducting direct currents corresponding to one another, and the choke is designed as a symmetrical toroidal core choke surrounding both electrical connections.

10. The power control of claim 1, wherein the printed circuit board has two electrical connections for conducting direct currents corresponding to one another, and the choke is designed as an asymmetrical toroidal core choke surrounding only one of the two electrical connections.

11. The power control of claim 2, wherein an electrically insulating thermally conductive element is mounted between the choke and the cooling element.

12. The power control of claim 3, wherein an electrically insulating thermally conductive element is mounted between the choke and the cooling element.

13. The power control of claim 2, wherein a cross section of the electrical connection is rectangular, having two short and two long sides, and the choke is connected to the cooling element in a thermally conductive manner in the region of a long side.

14. The power control of claim 3, wherein a cross section of the electrical connection is rectangular, having two short and two long sides, and the choke is connected to the cooling element in a thermally conductive manner in the region of a long side.

15. The power control of claim 2, wherein the electrical connection is designed as a conductive path on the printed circuit board.

16. The power control of claim 3, wherein the electrical connection is designed as a conductive path on the printed circuit board.

17. The power control of claim 4, wherein the electrical connection is designed as a separate element, electrically connected to the printed circuit board.

18. The power control of claim 2, wherein the choke comprises ferrite.

19. The power control of claim 4, wherein the printed circuit board has two electrical connections for conducting direct currents corresponding to one another, and the choke is designed as a symmetrical toroidal core choke surrounding both electrical connections.

20. The power control of claim 4, wherein the printed circuit board has two electrical connections for conducting direct currents corresponding to one another, and the choke is designed as an asymmetrical toroidal core choke surrounding only one of the two electrical connections.
